(19) United States
(12) Patent Application Publication
(10) Pub. No.: US 2026/0340752 A1
(43) Pub. Date: Oct. 29, 2026

(54) SYSTEM AND METHOD FOR VALIDATING OCCURRENCE OF AN EVENT AT A WORKSITE

(71) Applicant: Caterpillar Inc., Peoria, IL (US)

(72) Inventors: Pani Prithvi Raj, Chennai (IN); Sai Praveen Gundlapalli, Chennai (IN); Ashish Shah, Dunlap, IL (US)

(73) Assignee: Caterpillar Inc., Peoria, IL (US)

(21) Appl. No.: 19/188,051

(22) Filed: Apr. 24, 2025

(51) Int. Cl. G06Q 50/26; G06F 40/56; G06Q 50/08

(52) U.S. Cl. CPC G06Q 50/265; G06F 40/56; G06Q 50/08

(57) ABSTRACT

A system for validating occurrence of an event at a worksite from a generative artificial intelligence (GenAI) model is described. The system includes a processor configured to receive data pertinent to the event and process the data based on an obtained prompt using the GenAI model to: identify violation of at least one protocol during the event and a responsible party for the violation, determine whether the event is non-compliant upon comparison with one or more regulations applicable to the identified violation, and determine at least one change to at least one of: the event and the at least one protocol when the event is determined to be non-complaint. The processor is configured to generate a report identifying the responsible party and the at least one change to at least one of the event and the at least one protocol and display the report via a display device.

### TECHNICAL FIELD

The present disclosure relates to a system and a method for validating occurrence of an event at a worksite. More particularly, the present disclosure relates to the validating the occurrence of the event by generating a report associated with the event from a generative artificial intelligence (GenAI) model using prompt engineering.

### BACKGROUND

Many construction worksites include machines, equipment, and personnel to perform various functions. For example, a mining site may include excavators, haul trucks, and operators to mine ore or other resources and dispose of waste. However, the operations of such machines and personnel must be orchestrated to a protocol for safety, efficiency, and compliance. Accordingly, it is useful to monitor events at the worksite and take action to prevent violation of the protocol during such events based on the monitoring.

Korean patent 102313479 B1 relates to a system for providing a guide based on a safety standard using an artificial intelligence model. The system for providing the guide based on the safety standard using the artificial intelligence model comprises: an operator terminal; at least one camera module disposed on an operation site; and a server analyzing an operation site image collected by the at least one camera module, determining a state of an object included in the collected operation site image, and providing guide information on the at least one object to the operator terminal based on the determined state through the pre-trained artificial intelligence model. However, the artificial intelligence model described in Korean patent 102313479 B1 must be pre-trained on a plurality of work site images labeled with object information.

### SUMMARY

In one aspect, the present disclosure is directed to a system for validating occurrence of an event at a worksite from a generative artificial intelligence (GenAI) model. The system includes at least one sensor, at least one database, and a processor communicatively coupled to the at least one sensor and the at least one database. The at least one sensor is configured to capture data including at least one of a video or an audio pertinent to the event at the worksite. The at least one database is configured to store at least one protocol and a plurality of regulations associated with the worksite. The processor is configured to receive the captured data and obtain a prompt for the GenAI model. The processor is further configured to process the captured data based on the prompt using the GenAI model to: identify violation of the at least one protocol during the event at the worksite and a responsible party for the violation, determine and retrieve one or more regulations of the plurality of regulations applicable to the identified violation, determine whether the event is non-compliant upon comparison with the one or more regulations, and determine at least one change to at least one of: the event and the at least one protocol when the event is determined to be non-complaint. The processor is further configured to generate a report identifying the responsible party for the violation and the at least one change to at least one of: the event and the at least one protocol using the GenAI model and display the report to a user via a display device.

In another aspect, the present disclosure relates to a computer implemented method for validating occurrence of an event at a worksite from a generative artificial intelligence (GenAI) model. The method includes capturing, using at least one sensor, data including at least one of a video or an audio pertinent to the event at the worksite and storing, in at least one database, at least one protocol and a plurality of regulations associated with the worksite. The method further includes receiving, by a processor, the captured data from the at least one sensor and obtaining, by the processor, a prompt for the GenAI model. Further, the method includes processing, by the processor, the captured data based on the prompt using the GenAI model to: identify violation of the at least one protocol during the event at the worksite and a responsible party for the violation, determine and retrieve one or more regulations of the plurality of regulations applicable to the identified violation, determine whether the event is non-compliant upon comparison with the one or more regulations, and determine at least one change to at least one of: the event and the at least one protocol when the event is determined to be non-complaint. The method further includes generating, by the processor, a report identifying the responsible party for the violation and the at least one change to at least one of: the event and the at least one protocol using the GenAI model and displaying, by the processor, the report to a user via a display device.

In yet another aspect, the present disclosure relates to a non-transitory computer-readable medium comprising computer-executable instructions that, when executed by a processor, cause the processor to receive data including at least one of a video or an audio pertinent to an event at a worksite from at least one sensor and obtain a prompt for a generative artificial intelligence (GenAI) model. The processor is further configured to process the received data based on the prompt using the GenAI model to: identify violation of at least one protocol during the event at the worksite and a responsible party for the violation, determine and retrieve one or more regulations applicable to the identified violation, determine whether the event is non-compliant upon comparison with the one or more regulations, and determine at least one change to at least one of: the event and the at least one protocol when the event is determined to be non-complaint. The processor is further configured to generate a report identifying the responsible party for the violation and the at least one change to at least one of: the event and the at least one protocol using the GenAI model and display the report to a user via a display device.

### BRIEF DESCRIPTION OF THE DRAWINGS

FIG. 1 illustrates an exemplary worksite and one or more machines operating at the worksite, in accordance with an embodiment of the present disclosure;

FIG. 2 is a schematic view of a system for validating occurrence of an event at the worksite, in accordance with an embodiment of the present disclosure; and

FIG. 3 is a flowchart illustrating an exemplary method for validating occurrence of the event at the worksite, in accordance with an embodiment of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts. Generally, corresponding reference numbers may be used throughout the drawings to refer to the same or corresponding parts, e.g., 1, 1`, 1``, could refer to one or more comparable components used in the same or different depicted embodiments.

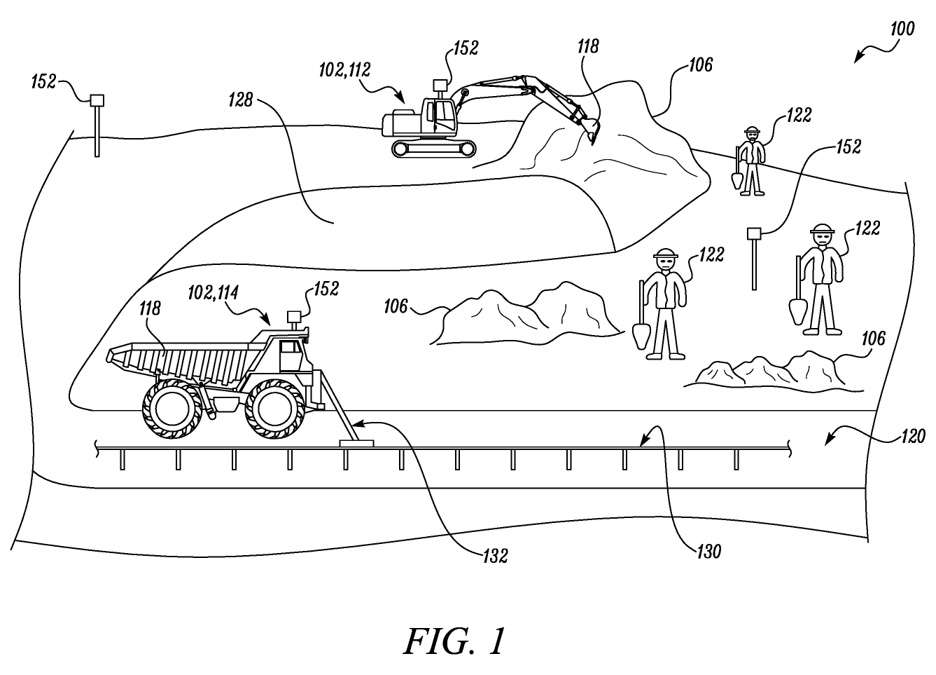

Referring to FIG. 1, an exemplary worksite 100 is shown. The worksite 100 may include any type of worksite known in the art, such as a mining site, a landfill, a quarry, a construction site, and the like. The worksite 100 may include varied terrains 128, such as, slopes, uneven ground, and other geological formations. The worksite 100 may also include stationary structures 130, such as, scaffolding, barriers, and other temporary or permanent installations. Additionally, the worksite 100 may incorporate various utility lines and equipment 132, such as exposed cables, pipes, and other infrastructure elements.

As shown in FIG. 1, the worksite 100 includes one or more machines 102 to accomplish a variety of tasks at the worksite 100. As an example, the machines 102 may collaborate and operate at or between different locations of the worksite 100, so as to transfer and/or move material 106, such as limestone, precious metal, copper, salt, nickel, granite, and the like, from one part of the worksite 100 to the other. The machines 102 may be of a variety of types capable of performing a variety of tasks. As an example, two machines 102 are illustrated in FIG. 1. One of the two machines 102 include the loading machine 112, while the other includes the hauling machine 114. A higher or a lower number of machines 102 may be contemplated.

The loading machine 112 may be adapted to lift, carry, and load the material that, for example, may be reduced by a digging machine (not shown), onto a hauling machine 114. Examples of the loading machine 112 may include a wheeled or tracked loader, a front shovel, an excavator (as shown in FIG. 1), a cable shovel, a stack reclaimer, or any other similar machine. The loading machine 112 may operate within common areas of the worksite 100 to load the materials (e.g., reduced materials) into the hauling machine 114. For example, the loading machine 112 may be deployed generally in a stationary state at a specific location of the worksite 100, but may include moving parts 118, e.g., linkage assemblies and buckets, that, in its stationary state, may facilitate a drawing and dumping of the materials 106, into the hauling machine 114.

The hauling machine 114 may be adapted to receive the materials from the loading machine 112 and carry the materials to a location where the materials may be unloaded. As an example, the worksite 100 may include pathways 120 along which the hauling machine 114 may travel to move the material from a load location to a dump location. After travelling to the dump location, and having unloaded (i.e., to dump) the materials 106 at the dump location, the hauling machine 114 may return to the same location (or, in some cases, a different load location) along the same pathway 120 (or, in some cases, along a different pathway). Examples of the hauling machine 114 may include an articulated truck, an off-highway truck, an on-highway truck, or any other similar machine.

As illustrated, the worksite 100 may also include personnel 122, including operators, workers, supervisors, and other individuals performing tasks related to the worksite 100. The personnel 122 may be employed at different locations throughout the worksite 100 to perform a variety of tasks. For example, the personnel 122 may be performing manual labor, operating the machines 102, overseeing operations, including operation of the machines 102, visiting the worksite 100, and/or performing other tasks.

During such operations, one or more events may occur at the worksite 100. The events may refer to any activity or action being performed at the worksite 100. The event may be a planned event or an unplanned event. For example, the planned event may correspond to the loading machine 112 scooping up and dumping the material 106 into the hauling machine 114 or the hauling machine 114 travelling from the load location to the dump location. The unplanned event may correspond to specific occurrences or incidents, such as, an accident, machine failure, or other occurrences that may result in injury, loss, or other physical, productivity, or economic harm. For example, the unplanned event may include, but is not limited to, the moving parts 118 of the loading machine 112 coming in close contact with the personnel 122, the hauling machine 114 straying from its intended pathways 120, the machine 102 falling off the terrain 128, or the hauling machine 114 moving in a close proximity to the personnel 122, the stationary structures 130 or the utility lines and equipment 132. Although not limited to specific examples disclosed herein, the event may refer to any activity or action occurring at the worksite 100.

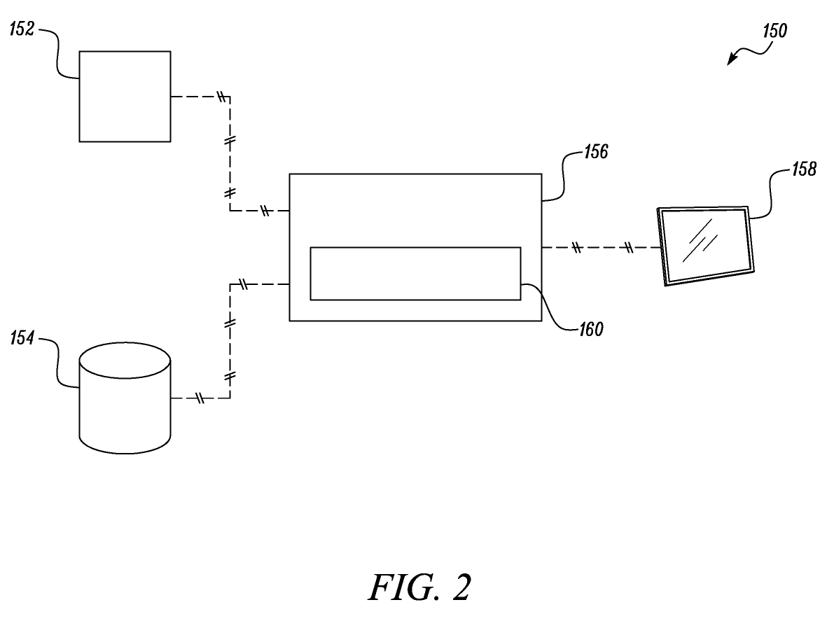

FIG. 2 illustrates a system 150 for validating occurrences of such events at the worksite 100. The system 150 may include at least one sensor 152, at least one database 154, a display device 158, and a processor 156 communicatively coupled to the at least one sensor 152, the at least one database 154, and the display device 158. The sensor 152 is configured to capture data pertinent to an event at the worksite 100. The captured data may correspond to at least one of a video, an audio, a text, or any form of data pertinent to the event at the worksite 100. As illustrated in FIG. 1, the sensors 152 may be deployed in a various ways, including being mounted on the machines 102, integrated into drones (not shown), or physically installed at various locations across the worksite 100.

The sensors 152 may include cameras (e.g., RGB, UV, IR, intensity, depth, etc.), microphones, location sensors (e.g., GPS, compass, etc.), inertial sensors (e.g., inertial measurement units, accelerometers, magnetometers, gyroscopes, etc.), environment sensors (e.g., temperature sensors, humidity sensors, light sensors, pressure sensors, etc.), LIDAR sensors, RADAR sensors, ultrasonic transducers, SONAR sensors, etc. The sensors 152 may be configured to sense events external to or internal of (e.g. in a cab of) the machine 102. By way of non-limiting example, the sensors 152 may include cameras trained on an exterior of the machine 102, e.g., to record video and/or images of an environment of the machine 102 and/or cameras trained on an interior of the machine 102, e.g., to record video and/or images of an operator of the machine 102. In further examples, the sensors 152 may also include wear sensors, e.g., to sense wear of components associated with the machines 102. The sensors 152 may also include safety-related sensors. For example, seat belt sensors may generate information indicative of whether a seat belt is being used. Similarly, other sensors may generate information indicative of proper use of other safety features. In addition to different types of sensors, the sensors 152 may also include multiple sensors of the same type. For example, a plurality of microphones, cameras, or LiDAR sensors may be disposed across different locations at the worksite 100, e.g., to provide information about the events occurring at the worksite 100.

Referring back to FIG. 2, the database 154 is configured to store a plurality of regulations and at least one protocol associated with the worksite 100. The regulations may refer to legally mandated standards, guidelines, and codes of practice to protect personnel (for example, personnel 122) working at a worksite from occupational hazards, injuries, and illnesses, and promote a safe and healthy work environment. The regulations may vary depending on a type of the worksite, a geographical location of the worksite, and various other factors. For example, the regulations may correspond to National Fire Protection Act (NFPA) Regulations, Mine Safety and Health Administration (MSHA) Regulations, and Environmental Protection Agency (EPA) Regulations. As an example, the regulations may indicate that any personnel working at a worksite must wear a high-visibility vest. In another example, the regulations may indicate that a distance between a personnel and a machine operating at a worksite should be greater than 2 meters. The protocol refers to a set of guidelines derived based on the regulations to mitigate risk and ensure the safe execution of tasks at the worksite. For example, the protocol is derived by adapting the legally mandated standards, guidelines, and codes of practice into operational infrastructure. As an example, the protocol may indicate that a machine operating at a worksite must maintain a safe distance of 4 meters from any personnel operating on a ground surface of the worksite. The database 154 may be either located at the worksite 100 or at a location that is distant from the worksite 100.

The processor 156 is configured to receive the captured data from the sensor 152. The processor 156 may be configured to receive the captured data from the sensor 152, e.g., by electrical transmission/translation means, which may exemplarily include a wired, a wireless communication network, and/or data links, such as a Controller Area Network (CAN) data links (not shown).

The processor 156 utilizes a generative artificial intelligence (GenAI) model 160 to process the received data from the sensor 152 to validate the occurrence of an event at the worksite 100. The GenAI model 160 is a type of large language model (LLM) that is trained on a large and diverse corpus of data. The GenAI model 160 is configured to generate any content across a wide range of domains and applications, not limited to validation of occurrence of events at the worksite 100, based on prompts or inputs provided to the GenAI model 160. The GenAI model 160 is also configured to generate an answer to a user’s query or set of queries in a natural language format. To this end, the GenAI model 160 may utilize a variety of large and small models to execute operations (e.g., tasks) to advance computational linguistics, generative artificial intelligence, and artificial intelligence. The large and small models serve a multitude of functions including Natural Language Understanding (NLU) for sentiment analysis, entity recognition, and classification; Natural Language Generation (NLG) for generating a report in a natural language format and dialogue systems; machine translation for multilingual communication; abstractive and extractive summarization of extensive data; sophisticated question answering systems; compliance verification; and unstructured data analysis for extracting actionable business intelligence. For example, the GenAI model is GPT-4o from OpenAI®. It would be appreciated by a person skilled in the art that GenAI models, such as, the GenAI model 160 are well known in the art, and hence the details related to the training and functionality of the GenAI model 160 are not provided here for the sake of brevity.

The processor 156 is configured to validate the occurrence of an event at the worksite 100 from the GenAI model 160 using prompt engineering. To this end, the processor 156 is configured to obtain a prompt from the user for the GenAI model 160 and process the captured data based on the prompt using the GenAI model 160. In an embodiment, the processor 156 is configured to receive the captured data subsequent to obtaining the prompt.

The prompt corresponds to an input that is provided by the user to the GenAI model 160 to guide the GenAI model 160 for validating the occurrence of the event at the worksite 100. The prompt may include context, one or more instructions, and one or more output indicators for the GenAI model 160 to process the captured data. The context may refer to additional information or context associated with the captured data to guide the GenAI model 160 to generate relevant output. For example, when the captured data is a video, the context details may indicate to the GenAI model 160 that it has to act like an expert construction safety officer and analyze the video from the worksite 100. The instruction may indicate a specific task or instruction for the GenAI model 160. For example, the instructions may indicate to the GenAI model 160 to conduct a frame-by-frame analysis of the video to determine the relative motion of the machine 102 and the personnel 122 and identify violation of a protocol when the distance between the machine 102 and the personnel 122 is less than a predefined threshold. The output indicators may indicate the type or format of the output. For example, the output indicator may instruct the GenAI model 160 to generate an output stating whether there was a violation of the protocol or any regulation. The output indicator may also indicate that the output must be provided in a tabular format. Although not limited to specific examples disclosed herein, it would be appreciated by a person skilled in the art that the prompt may include different context, instructions, and output indicators and can include more specifics and details, depending upon the requirement of the user.

The processor 156 may be configured to obtain the prompt based on the protocol and the regulations associated with the worksite 100. To this end, the processor 156 may be configured to receive the protocol and the regulations associated with the worksite 100 from the database 154, e.g., by electrical transmission/translation means, which may exemplarily include a wired, a wireless communication network, and/or data links, such as a Controller Area Network (CAN) data links (not shown). The processor 156 is further configured to formulate the prompt for the GenAI model 160 based on the protocol and the regulations. For example, when the protocol indicates that a machine operating at a worksite must maintain a safe distance of 4 meters from any personnel operating on a ground surface of the worksite, the processor 156 may be configured to formulate the instructions in the prompt to identify violation of a protocol when the distance between the machine 102 and the personnel 122 is less than 4 meters.

The processor 156 is configured to process the captured data based on the prompt using the GenAI model 160 to identify violation of the protocol during the event at the worksite and a responsible party for the violation. To this end, the processor 156 is configured to identify the violation of the protocol during the event by comparing the instruction in the prompt with at least one activity performed during the event using the GenAI model 160. The processor 156 is further configured to identifying the violation of the protocol when the at least one activity performed during the event deviates from the at least one instruction in the prompt. For example, when the activity indicates that the machine 102 is moving towards the personnel 122 and the distance between the machine 102 and the personnel 122 is less than 4 meters and the protocol indicates that the distance between the machine 102 and the personnel 122 should be greater than 4 meters, the processor 156 is configured to identify the event as the violation of the protocol. Similarly, the processor 156 may be configured to identify the responsible party for the violation depending on whether the machine 102 is moving towards the personnel 122 or the personnel 122 is moving towards the machine 102. In an example, when the machine 102 is moving towards the personnel 122, the processor 156 may identify the machine 102 as the responsible party for the violation. In another example, if the personnel 122 is not wearing any high-visibility vest, the processor 156 may identify the personnel 122 as the responsible party for the violation.

The processor 156 is further configured to determine and retrieve one or more regulations of the plurality of regulations applicable to the identified violation from the database 154. For example, when the violation relates to the distance between the machine 102 and the personnel 122, the processor 156 is configured to determine and retrieve the regulations associated with legally mandated distance between the machine 102 and the personnel 122. In an embodiment, the processor 156 is configured to determine and retrieve the regulations as per the instructions provided in the prompt.

The processor 156 is further configured to determine whether the event is non-compliant upon comparison with the one or more regulations. For example, when the distance between the machine 102 and the personnel 122 is less than 2 meters, the processor 156 may determine that the event is non-complaint.

The processor 156 is further configured to determine at least one change to at least one of: the event and the protocol when the event is determined to be non-complaint. The processor 156 is configured to determine a change to the event based on one or more actions or activities performed during the event. For example, the processor 156 may determine that the proximity sensors or alarms should be installed to alert the machine 102 in case of any violation.

The processor 156 is configured to determine whether the protocol is consistent with the regulations. When it is determined that the protocol is inconsistent with the regulations, the processor 156 is configured to identify changes to be made to the protocol. For example, when the protocol indicates that the distance between the machine 102 and the personnel 122 working at the worksite 100 should be greater than 4 meters and the regulations indicate that the legally mandated distance between the machine 102 and the personnel 122 working at the worksite 100 should be greater than 5 meters, the processor 156 is configured to determine a change to be made to the protocol to change the distance from 4 meters to 5 meters.

The processor 156 is further configured to generate the report identifying the responsible party for the violation and the at least one change to at least one of: the event and the at least one protocol using the GenAI model 160. The processor 156 is configured to generate the report in a natural language format. The processor 156 is further configured to generate the report in a format determined based on the output indicators included in the prompt. In an embodiment, the report also indicates one or more actions to be performed to optimize operations at the worksite 100. For example, the actions may indicate that the movement of the machine 102 should have been halted before encroaching the 4-meter safety boundary.

The processor 156 is further configured to display the report to the user via the display device 158. The display device 158 may correspond to any display device 158 located either at the worksite 100 or at a location that is distant from the worksite 100. The processor 156 is configured to obtain a user feedback on the generated report, for example, via one or more input mechanisms coupled either to the display device 158 or the processor 156. The processor 156 is further configured to fine-tune the GenAI model 160 based on the obtained feedback to optimize identification of the responsible party for the violation and determination of the at least one change to at least one of: the event and the at least one protocol. In an embodiment, the processor 156 is also configured to modify the prompt based on the obtained feedback from the user.

The processor 156 is configured to receive a query related to the event and utilize the generated report to provide context to the GenAI model 160 to generate a response to the query based on the captured data. To this end, the processor 156 may be configured to provide an interactive interface combined with the GenAI model 160 to generate responses to the query or set of queries. The processor 156, upon receiving the query via the interactive interface, utilizes the generated report to understand the context of the query and generate responses accordingly. The processor 156 is further configured to display the response to the user via the display device 158. The processor 156 is configured to receive the query and generate the response in a natural language format.

The processor 156 may be one or more of a microprocessor, a microcontroller, an electronic control module (ECM), an electronic control unit (ECU), or any other suitable means for performing the one or more operations described above. The processor 156 may be implemented using one or more controller technologies, such as Application Specific Integrated Circuit (ASIC), Reduced Instruction Set Computing (RISC) technology, Complex Instruction Set Computing (CISC) technology or any other similar technology now known or developed in the future. In some embodiments, a set of computer executable instructions may be provided in any computer readable medium, e.g., any non-transitory computer readable medium, and which when executed by the processor 156 may result in one or more of the functions as described above. The processor 156 may be either located at the worksite 100 or at a location that is distant from the worksite 100.

The processor 156 may include a memory (not shown), for example, a hard disk drive (HDD) and a secure digital (SD) card. Further, the memory may include non-volatile/volatile memory units such as a random-access memory (RAM) / a read only memory (ROM), which may include associated input and output buses. The memory may be configured to store the GenAI model 160 and various other instructions sets for various other functions, along with the set of instructions, described above.

### Industrial Applicability

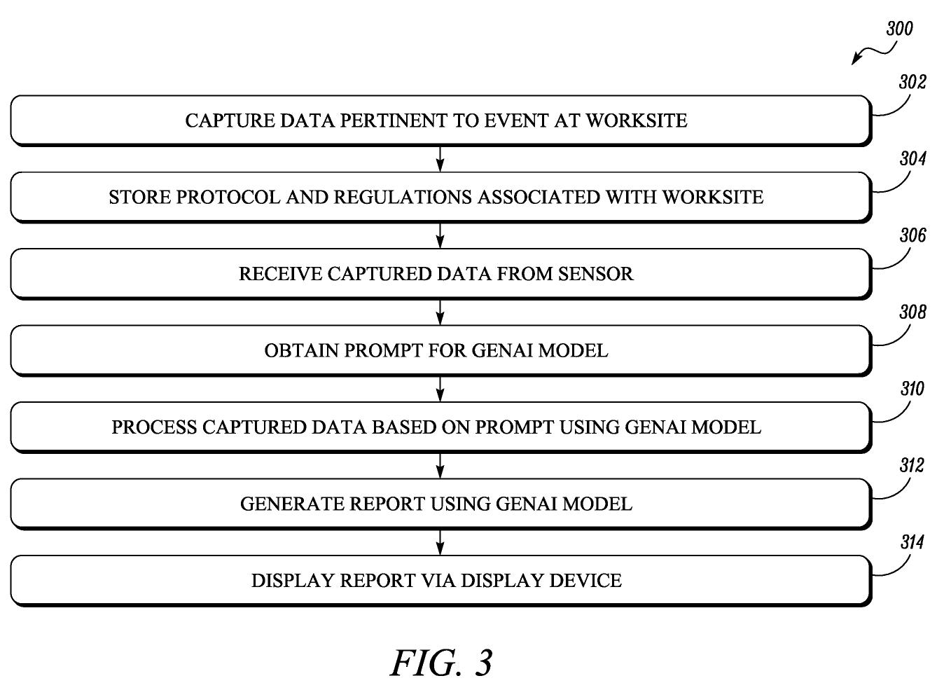

To maintain a safe, efficient, and legally complaint work environment, it becomes essential to ensure that the activities or operations performed at the worksite 100 are monitored for compliance with one or more protocols and the defined regulations. Traditional monitoring methods often rely on manual inspections that often results in inaccurate reporting due to factors like human error, inconsistency, and time-consuming data collection process. FIG. 3 illustrates an exemplary computer implemented method to validate occurrence of such events at the worksite 100 from the GenAI model 160. Moreover, the method is implemented using prompt engineering, thereby reducing the need for extensive training of the GenAI model 160 based on training data associated with the worksite 100. The method is discussed by way of a flowchart 300 that illustrates exemplary steps associated with the method.

The method begins with the sensor 152 capturing data including at least one of the video or the audio pertinent to the event at the worksite 100 at block 302. At block 304, the database 154 stores the at least one protocol and the plurality of regulations associated with the worksite 100. At block 306, the processor 156 receives the captured data from the sensor 152 and obtains the prompt for the GenAI model 160 at block 308. At block 310, the processor 156 processes the captured data based on the prompt using the GenAI model 160 to identify the violation of the at least one protocol during the event at the worksite 100 and the responsible party for the violation, determine and retrieve the one or more regulations of the plurality of regulations applicable to the identified violation, determine whether the event is non-compliant upon comparison with the one or more regulations, and determine at least one change to at least one of: the event and the at least one protocol when the event is determined to be non-complaint. At block 312, the processor 156 generates the report identifying the responsible party for the violation and the at least one change to at least one of: the event and the at least one protocol using the GenAI model 160. At block 314, the processor 156 displays the report to the user via the display device 158.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the present disclosure (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word "or" refers to any possible permutation of a set of items. For example, the phrase "A, B, or C" refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the system, method, and/or the work machine of the present disclosure without departing from the scope of the disclosure. Other embodiments will be apparent to those skilled in the art from consideration of the specification and practice of the system, method, and/or the work machine disclosed herein. It is intended that the specification and examples be considered as exemplary only, with a true scope of the disclosure being indicated by the following claims and their equivalent.

What is claimed is:

1. A system for validating occurrence of an event at a worksite from a generative artificial intelligence (GenAI) model, the system comprising:
at least one sensor configured to:
capture data including at least one of a video or an audio pertinent to the event at the worksite;
at least one database configured to:
store at least one protocol and a plurality of regulations associated with the worksite; and
a processor communicatively coupled to the at least one sensor and the at least one database, the processor configured to:
receive the captured data;
obtain a prompt for the GenAI model;
process the captured data based on the prompt using the GenAI model to:
identify violation of the at least one protocol during the event at the worksite and a responsible party for the violation,
determine and retrieve one or more regulations of the plurality of regulations applicable to the identified violation,
determine whether the event is non-compliant upon comparison with the one or more regulations, and
determine at least one change to at least one of: the event and the at least one protocol when the event is determined to be non-complaint;
generate a report identifying the responsible party for the violation and the at least one change to at least one of: the event and the at least one protocol using the GenAI model; and
display the report to a user via a display device.

2. The system of claim 1, wherein the processor is configured to obtain the prompt by:
receiving the at least one protocol and the plurality of regulations associated with the worksite from the at least one database; and
formulating the prompt for the GenAI model based on the at least one protocol and the plurality of regulations.

3. The system of claim 1, wherein the processor is configured to:
obtain a user feedback on the generated report; and
fine-tune the GenAI model based on the obtained feedback to optimize identification of the responsible party for the violation and determination of the at least one change to at least one of: the event and the at least one protocol.

4. The system of claim 1, wherein the processor is configured to identify the violation of the at least one protocol during the event by:
comparing at least one instruction in the prompt with at least one activity performed during the event using the GenAI model; and
identifying the violation of the at least one protocol when the at least one activity performed during the event deviates from the at least one instruction in the prompt.

5. The system of claim 1, wherein the report indicates one or more actions to be performed to optimize operations at the worksite.

6. The system of claim 1, wherein the processor is further configured to:
receive a query related to the event;
utilize the generated report to provide context to the GenAI model to generate a response to the query based on the captured data; and
display the response to the user via the display device.

7. The system of claim 1, wherein the GenAI model is a Large Language Model (LLM) capable of generating the report in a natural language format.

8. The system of claim 1, wherein the processor is configured to receive the captured data subsequent to obtaining the prompt.

9. A computer implemented method for validating occurrence of an event at a worksite from a generative artificial intelligence (GenAI) model, the method comprising:
capturing, using at least one sensor, data including at least one of a video or an audio pertinent to the event at the worksite;
storing, in at least one database, at least one protocol and a plurality of regulations associated with the worksite;
receiving, by a processor, the captured data from the at least one sensor;
obtaining, by the processor, a prompt for the GenAI model;
processing, by the processor, the captured data based on the prompt using the GenAI model to:
identify violation of the at least one protocol during the event at the worksite and a responsible party for the violation,
determine and retrieve one or more regulations of the plurality of regulations applicable to the identified violation,
determine whether the event is non-compliant upon comparison with the one or more regulations, and
determine at least one change to at least one of: the event and the at least one protocol when the event is determined to be non-complaint;
generating, by the processor, a report identifying the responsible party for the violation and the at least one change to at least one of: the event and the at least one protocol using the GenAI model; and
displaying, by the processor, the report to a user via a display device.

10. The method of claim 9, wherein obtaining the prompt includes:
receiving, by the processor, the at least one protocol and the plurality of regulations associated with the worksite from the at least one database; and
formulating, by the processor, the prompt for the GenAI model based on the at least one protocol and the plurality of regulations.

11. The method of claim 9 further comprising:
obtaining, by the processor, a user feedback on the generated report; and
fine-tuning, by the processor, the GenAI model based on the obtained feedback to optimize identification of the responsible party for the violation and determination of the at least one change to at least one of: the event and the at least one protocol.

12. The method of claim 9, wherein identifying the violation of the at least one protocol during the event comprises:
comparing, by the processor, at least one instruction in the prompt with at least one activity performed during the event using the GenAI model; and
identifying, by the processor, the violation of the at least one protocol when the at least one activity performed during the event deviates from the at least one instruction in the prompt.

13. The method of claim 9, wherein the report indicates one or more actions to be performed to optimize operations at the worksite.

14. The method of claim 9, further including:
receiving, by the processor, a query related to the event;
utilizing, by the processor, the generated report to provide context to the GenAI model to generate a response to the query based on the captured data; and
displaying, by the processor, the response to the user via the display device.

15. The method of claim 9, wherein the GenAI model is a Large Language Model (LLM) capable of generating the report in a natural language format.

16. The method of claim 9, wherein the captured data is received subsequent to obtaining the prompt.

17. A non-transitory computer-readable medium comprising computer-executable instructions that, when executed by a processor, cause the processor to:
receive data including at least one of a video or an audio pertinent to an event at a worksite from at least one sensor;
obtain a prompt for a generative artificial intelligence (GenAI) model;
process the received data based on the prompt using the GenAI model to:
identify violation of at least one protocol during the event at the worksite and a responsible party for the violation,
determine and retrieve one or more regulations applicable to the identified violation,
determine whether the event is non-compliant upon comparison with the one or more regulations, and
determine at least one change to at least one of: the event and the at least one protocol when the event is determined to be non-complaint;
generate a report identifying the responsible party for the violation and the at least one change to at least one of: the event and the at least one protocol using the GenAI model; and
display the report to a user via a display device.

18. The non-transitory computer-readable medium of claim 17, wherein the computer-executable instructions, when executed, cause the processor to obtain the prompt by:
receiving the at least one protocol and the plurality of regulations associated with the worksite from the at least one database; and
formulating the prompt for the GenAI model based on the at least one protocol and the plurality of regulations.

19. The non-transitory computer-readable medium of claim 17, wherein the computer-executable instructions, when executed, cause the processor to:
obtain a user feedback on the generated report; and
fine-tune the GenAI model based on the obtained feedback to optimize identification of the responsible party for the violation and determination of the at least one change to at least one of: the event and the at least one protocol.

20. The non-transitory computer-readable medium of claim 17, wherein the computer-executable instructions, when executed, cause the processor to:
compare at least one instruction in the prompt with at least one activity performed during the event using the GenAI model; and
identify the violation of the at least one protocol when the at least one activity performed during the event deviates from the at least one instruction in the prompt.
